(19) United States
(12) Patent Application Publication
(10) Pub. No.: US 2006/0031626 A1
(43) Pub. Date: Feb. 9, 2006

(54) Field device for automation technology

(75) Inventors: Dirk Rapp, Lorrach (DE); Stefan Maier, Rheinfelden (DE); Hans Kornmeier, Freiburg (DE)

Correspondence Address: BACON & THOMAS, PLLC, 625 SLATERS LANE, FOURTH FLOOR, ALEXANDRIA, VA, 22314, US

(73) Assignee: Endress + Hauser GmbH + Co. KG, Maulburg (DE)

(21) Appl. No.: 11/195,601

(22) Filed: Aug. 3, 2005

Related U.S. Application Data
(60) Provisional application No. 60/604,432, filed on Aug. 26, 2004.

(30) Foreign Application Priority Data
Aug. 3, 2004 (DE) 10 2004 037 785.5

(51) Int. Cl. G06F 12/00

(52) U.S. Cl. 711/103; 711/163

(57) ABSTRACT

In an automation technology field device having a microprocessor P and a non-volatile, writable data memory NVM for storing parameter values, the data memory having a predetermined maximum number WAmax of write accesses per memory location ML, a counter C is provided for counting write accesses WA to the data memory NVM. Additionally, a memory management unit MMU is provided, which evaluates the reading of the counter C, and prevents an exceeding of the maximum number WAmax of write accesses to a memory location ML.

In automation technology, field devices are used in many cases. They serve to measure and/or influence process variables. Examples of field devices for measurement are fill level measuring devices, mass-flow measuring devices, pressure and temperature measuring devices, pH and conductivity measuring devices, etc., which, as sensors, register the corresponding process variables fill level, flow rate, pressure, temperature, pH-value, and conductivity, respectively.

Actuators are field devices serving to influence process variables, e.g. such as valves which control the flow rate of a liquid in a piping section, or as pumps which control the fill level in a container.

Recording devices, which record measurement data on location, are also referred to as field devices.

A wide variety of field devices are manufactured and sold by the company Endress+Hauser.

Field devices in modern automation installations are normally connected via field bus systems (HART, Profibus, Foundation Fieldbus, etc.) with superordinated units (e.g. control systems or control units) serving for, among other things, process control, process visualization, or process monitoring.

Field bus systems are, for the most part, integrated into enterprise networks. Process data, respectively field device data, can then be accessed from different areas of an enterprise. For worldwide communication, the company networks can also be connected with public networks, e.g. the Internet.

Modern field devices have, for the most part, a standardized field bus interface for communicating with an open field-bus-system.

In many cases, the field devices are integrated into large automation systems. There, the measured values of the sensors are cyclically communicated via the field bus and evaluated, and control signals for the actuators are transmitted via the field bus. The control can be effected centrally using a programmable logic controller PLC, or a process control system PCS. However, a decentralized control distributed among the field devices is also possible.

For the user, the following criteria for field devices in automation systems are important: Interchangeability, interconnectivity, interoperability.

To ensure reliable control using field devices of different manufacturers, a number of parameters necessary for operation and communication via the bus system are defined for the field devices in the specifications for the various field bus systems.

The device-parameters can essentially be divided into three groups, as follows.

Dynamic process parameters, like measured values, control values, and status values, which are necessary for controlling automation installations. These parameters change with respect to time. They are read, respectively written, cyclically, and are communicated via the bus.

Operational and standard parameters, which define certain device functions and settings. These parameters are only read, respectively written, acyclically.

Manufacturer-specific parameters, which define manufacturer-specific functions, respectively settings.

Depending on parameter type, the parameters are stored in a volatile memory (e.g. RAM) or a non-volatile memory (e.g. EEPROM).

However, EEPROM memories allow only a limited number of write accesses. Above a predetermined maximum number, manufacturers of EEPROM's will no longer guarantee reliable write accesses.

For example, the specification for the 16 KBit EEPROM of the type 24C164 of the company ATMEL is 1 million write accesses per memory location (memory cell). Under normal operating conditions with one write access in approximately five minutes, this yields a service life of about 10 years. The typical length of service lives of field devices lies above this value. When the frequency of write accesses is increased, the service life of the EEPROM-memory is correspondingly shortened.

When, in a field device, a parameter value can no longer be written, this leads to a device error. Depending on the device software (firmware) used, this error can lead to a failure of the device, and thus to an interruption of the entire process control, and to possible downtime of the installation. For installations with a multitude of field devices (sometimes over 100), the error search is always very involved.

An object of the invention is therefore to provide a field device which does not have the aforementioned disadvantages, and which especially enables error-free storage of various parameter values over the entire service life of the field device.

This object is achieved by the features provided in the independent claims.

Advantageous further developments are provided in the dependent claims.

An essential idea of the invention is to provide a counter and a memory management unit in an automation technology field device having a microprocessor and a non-volatile, writable data memory for storing parameter values, designed for a predetermined maximum number of write accesses. The counter serves to count the write accesses to the data memory. The memory management unit evaluates the counter reading and prevents the maximum number of write accesses to the data memory from being exceeded.

Through this, the failure of a field device due to write-errors can be effectively prevented, or a possible failure of the memory is delayed to the extent that it will not realistically occur during the typical service life of a field device.

In a further development of the invention, the memory management unit generates an error report when the danger of a memory failure exists, or is foreseeable. The plant operator is thereby informed of the impending failure of a field device, and can take appropriate countermeasures. Frequently, repeated write accessing of a parameter results from faulty programming, which can thereby be recognized and corrected.

In a further development of the invention, the memory management unit enables the changing of the memory location of at least one parameter.

By relocating the memory location, a too-frequently occurring write access to a specific memory location is very simply prevented.

In a further development of the invention, the counter counts the write accesses to the entire data memory. Such a counter requires very little or no programming effort at all. Such a counter is already specified by Profibus and Foundation Fieldbus, and it bears the label “static revision counter.”

In an alternative, further development of the invention, the counter counts the write accesses to a memory range. With this measure, a memory range which is accessed too frequently can be recognized.

In an alternative, further development of the invention, the counter counts the write accesses to individual memory locations. This requires greater computing and memory effort, since for each parameter the corresponding counter reading must be determined and saved.

In a further development of the invention, the memory management unit enables the relocating of individual memory locations of the parameters.

In an alternative further development of the invention, the memory management unit enables the relocating of individual memory blocks.

In a further development of the invention, the relocating of memory locations or memory blocks is accomplished in a predetermined way.

In a further development of the invention, the relocating of memory locations or memory blocks is accomplished randomly.

In a further development of the invention, a volatile data memory is provided, where the memory management unit outsources the storage of parameters with frequent write accesses. Only certain representative values of these parameters are stored in the non-volatile data memory.

In a further development of the invention, a volatile data memory is provided, which has a memory range, which, in the case of an interruption of the voltage supply of the field device, is automatically stored in the non-volatile data memory. The memory management unit outsources parameters with frequent write accesses into this memory range of the volatile memory.

In an alternative embodiment of the invention, the field device has an MRAM- or FRAM-memory as non-volatile, writable data memory for storing parameter values.

In an alternative embodiment of the invention, an internal voltage supply unit is provided, which, in case of failure of the external voltage supply of the field device, prevents a loss of data in the data memory. This possibility is, in principle, provided only for field devices which are not subject to limitations with regard to Ex-safety. For Ex-devices, such a solution would be very complex, and thus very expensive.

The invention will now be explained in greater detail on the basis of an example of an embodiment illustrated in the drawings, the figures of which show as follows:

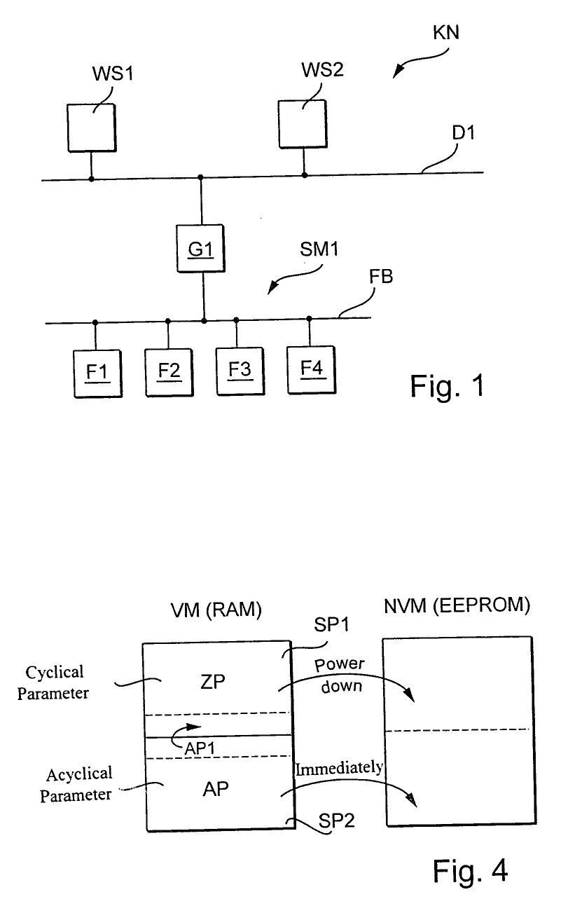

FIG. 1 schematic illustration of a process automation technology network having multiple field devices;

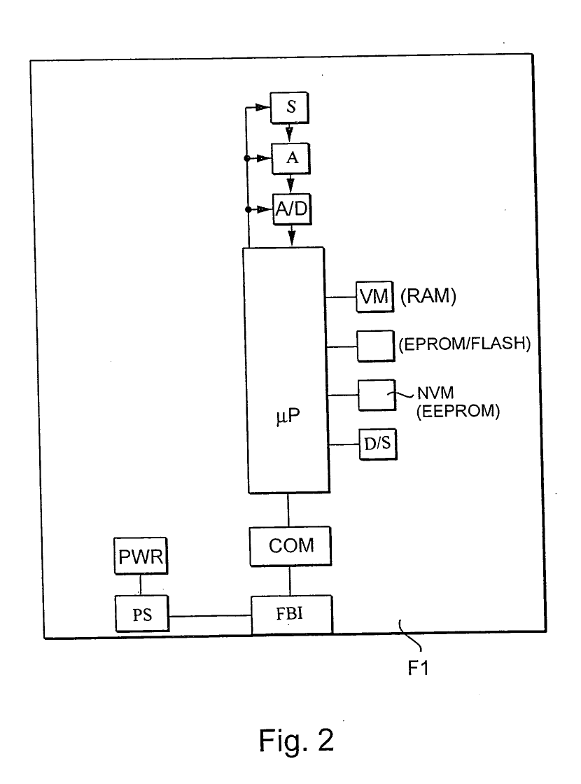

FIG. 2 block diagram of a field device;

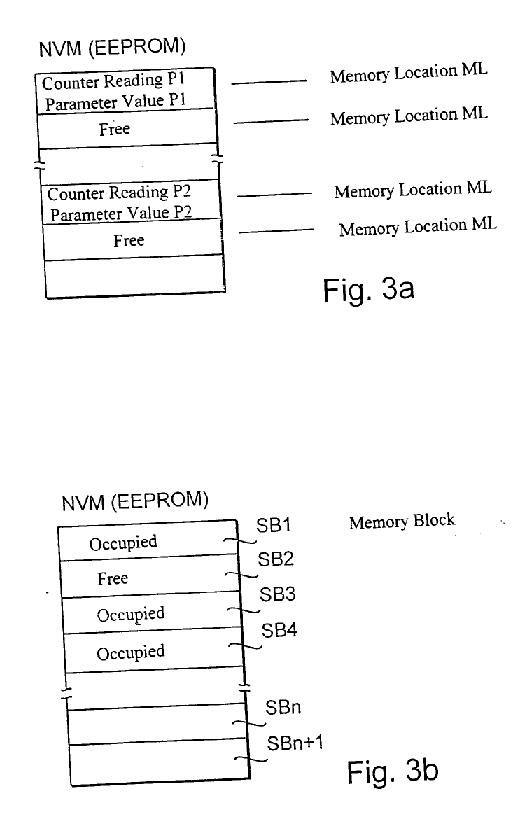

FIGS. 3a, 3b memory with multiple memory locations;

FIG. 4 two separated memories.

FIG. 1 illustrates a network for automation technology in more detail. Multiple computing units in the form of smaller work stations WS1, WS2 are connected to a data bus D1. These computing units serve as superordinated units (control systems or control units), for, among other things, process visualization, process monitoring, and engineering, as well as for operating and monitoring field devices. The data bus D1 works e.g. according to the Profibus DP-standard, or according to the HSE (High Speed Ethernet)-standard of Foundation Fieldbus.

Data bus D1 is connected with a field bus segment SM1 via a gateway G1, also referred to as a linking device or segment coupler. The field bus segment SM1 is composed of multiple field devices F1, F2, F3, F4, which are connected with one another via a field bus FB. The field devices F1, F2, F3, F4 can be sensors or actuators, or mixtures of both. The field bus FB works according to one of the known field bus standards Profibus, Foundation Fieldbus, or HART.

FIG. 2 illustrates in greater detail a block diagram of a field device, e.g. F1, of the invention. A microprocessor μP is connected via an analog-digital converter A/D and an amplifier A with a sensor S, which registers a process variable (e.g. pressure, flow rate, or fill level). The microprocessor μP is also connected with multiple memories, as follows. A volatile memory VM serves as temporary working memory RAM. A further memory EPROM or flash memory FLASH serves as memory for the control program to be executed in the microprocessor. In a non-volatile, writable memory NVM, parameter values (e.g. calibration data, etc.) are stored. The memory NVM is a writable EEPROM-memory, which is designed only for a specific, predetermined maximum number of write accesses (e.g. the 1 million accesses, 16 KBit EEPROM 24C164 of the company ATMEL).

The control program defines the functions relating to the application of the field device (measured value calculation, envelope curve evaluation, linearization of the measured values, diagnostic tasks). Furthermore, the microprocessor is connected with a display/service unit D/S (e.g. LCD-display with multiple push-buttons). For communicating with the field bus segment SM1, the microprocessor is connected via a communications controller COM with a field bus interface FBI. A power section PS, fed by the field bus, supplies the necessary power for the individual electronic components of the field device F1. For clarity, the supply lines to the individual electronic components are not shown.

The operation of the invention will now be described in greater detail.

The field devices F are integrated into an automation system. Sensor data and actuator data are cyclically communicated via the field bus FB. During operation, parameters, under direction of the control program, are read out of the data memory NVM, or written into the memory, as the case may be.

Provided in the microprocessor μP is a counter, which counts the write accesses WA to the data memory NVM. In this, the write accesses WAML to a specific memory location ML, the write accesses WAMB to a memory block MB, or the write accesses WAME to the entire memory can be counted.

Further provided in the microprocessor μP is a memory management unit MMU, which correspondingly evaluates the counter reading C.

Thus, the memory management unit MMU can generate an error report when the danger exists, or is foreseeable, that the maximum number WAmax of write accesses to the memory NVM will be reached. As a result of this, the plant operator can initiate appropriate measures to counteract this danger.

FIG. 3a shows how the counter reading C and the value of a parameter P1 are stored in the data memory NVM at a memory location ML1. The memory location ML1′ is free, but it is already allocated for the parameter P1.

When the maximum counter reading WAmax for a parameter P1 is reached, the memory management unit MMU arranges for the memory location ML of this parameter P1 to be relocated to a free memory location ML1′, and for the memory location ML1 to be marked as consumed. The marking is necessary so that this memory location can no longer be written to.

By relocating the memory location, write access errors can no longer occur.

The relocating to a free memory location can also be accomplished randomly. The memory management unit MMU checks which locations in the memory are free, and relocates the memory location of the parameter P1 to one of these free memory locations.

FIG. 3b illustrates occupied and free memory blocks MB1, MB2 . . . . If the counter reading C of a memory block, e.g. MB1, reaches the maximum value WAmax, then the entire memory block is relocated, as described above.

By relocating memory blocks, write access errors can likewise no longer occur.

FIG. 4 illustrates the memory range of the volatile memory VM. The memory VM is divided into two memory ranges, CP for cyclical parameters and AP for acyclical parameters. The acyclical parameters normally are written immediately to the non-volatile data memory NVM. Cyclical parameters are written to the non-volatile memory by means of the memory management unit MMU only in the case of an interruption of the supply voltage of the field device F. For this automatic backup, a small power reserve, the internal voltage supply unit PWR, is necessary to supply required power for writing the data. The more parameter values which must be stored, the bigger the power reserve must be.

Parameters Pi with frequent write accesses can thus be outsourced, by means of the memory management unit MMU, into the memory range of the volatile memory VM, which, in the case of an interruption of the supply voltage, is automatically backed up. Through this, frequent write accesses to the non-volatile memory can be avoided, and nevertheless the parameter values are not lost. This possibility is, in principle, provided only for field devices which are not subject to limitations with regard to Ex-safety. For Ex-devices, such a solution with a power reserve would be very complex, and thus very expensive.

In an alternative embodiment of the invention, the field device has an MRAM- or FRAM-memory as non-volatile, writable data memory NVM for storing parameter values.

These magnetic memories allow more write-accesses than EEPROM-memories, such that frequent write-accesses to these memories also cannot lead to errors.

Alternatively, the memory management unit MMU can outsource parameters Pi with frequent write accesses to the volatile memory VM, and only representative values R of the parameters Pi are stored in the non-volatile data memory NVM. Through this, the frequent write accesses are accomplished to the volatile memory VM, which is not subject to any limitation with regard to the write accesses.

The memory management unit MMU and the counter C are integrated, in the simplest way, into the device software of the field device F.

1-13. (canceled)

14. An automation technology field device, having:
a microprocessor; and
a non-volatile, writable, data memory for storing parameter values and designed for a predetermined maximum number of write accesses per memory location, wherein:
said field device comprises a counter for the write accesses to the data memory, and a memory management unit, which evaluates the reading of said counter and prevents an exceeding of the maximum number of write accesses to a memory location.

15. The field device as claimed in claim 14, wherein:
said memory management unit generates an error report when the danger of exceeding the maximum number of write accesses exists, or is foreseeable.

16. The field device as claimed in claim 14, wherein:
said counter counts the write accesses to the entire data memory.

17. The field device as claimed in claim 14, wherein:
said counter counts the write accesses to a memory block of the data memory containing multiple parameter values.

18. The field device as claimed in claim 14, wherein:
said counter counts the write accesses to a memory location of the data memory.

19. The field device as claimed in claim 14, wherein:
said memory management unit relocates the memory location of at least one parameter.

20. The field device as claimed in claim 14, wherein:
said memory management unit relocates the memory location at least of one memory block.

21. The field device as claimed in claim 14, wherein:
said memory management unit predictably changes the memory location.

22. The field device as claimed in one of the preceding claim 14, wherein:
said management unit randomly changes the memory location.

23. An automation technology field device, having:
a microprocessor;
a non-volatile, writable data memory for storing parameter values;
a volatile data memory; and
a memory management unit which outsources the storage of parameters of frequent write access to said volatile memory and stores only representative values of the parameters in said non-volatile data memory.

24. An automation technology field device, having:
a microprocessor;
a non-volatile, writable data memory for storing parameter values;
a volatile data memory provided; and
a memory management unit which outsources the storage of parameters of frequent write access to a memory range of said volatile memory, wherein:
memory range is automatically stored in said non-volatile data memory in the case of an interruption of the supply voltage of the field device.

25. An automation technology field device, having:
a microprocessor;
and a non-volatile, writable data memory for storing parameter values, wherein:
data memory is an MRAM- or FRAM-memory.

26. An automation technology field device, having:
a microprocessor;
a volatile, writable data memory for storing parameter values; and
an internal voltage supply unit, which, in case of failure of the external voltage supply of the field device, prevents a loss of data in said data memory.
